(19) United States
(12) Patent Application Publication
(10) Pub. No.: US 2026/0228188 A1
(43) Pub. Date: Aug. 6, 2026

(54) REMOTE EVALUATION SYSTEM WITH DYNAMIC MULTIMEDIA RESPONSE

(71) Applicant: J.Johnston E-learning & Consulting Inc., St. Catharines (CA)

(72) Inventor: Janet JOHNSTON, St. Catharines (CA)

(73) Assignee: J.Johnston E-learning & Consulting Inc., St. Catharines (CA)

(21) Appl. No.: 19/046,621

(22) Filed: Feb. 6, 2025

(51) Int. Cl. G06F 16/21; G06F 16/435

(52) U.S. Cl. CPC G06F 16/212; G06F 16/435

(57) ABSTRACT

A method includes: storing, in a non-volatile data repository, an evaluation component with a query module and at least three response instances, where one is a validation-positive response and the others are validation-negative responses; for each validation-negative response, storing a distinct media payload and mapping it exclusively to its respective response instance; transmitting the evaluation component from a source node to a target node over a network; receiving, at the source node, a response selection identifier from the target node specifying a selected response; querying the data repository to retrieve the media payload linked to the selected response; delivering the retrieved media payload to the target node to trigger an output event; and initiating a monitoring sequence to detect an activation condition related to the output event, which, upon satisfaction, outputs an indicator on the target node indicating the validation-positive response instance.

### FIELD

The present disclosure relates to computer-implemented methods and systems for adaptive evaluation processing in digital environments and, more particularly, to dynamically deliver multimedia-based feedback associated with selected response instances, while minimizing computational overhead.

### BACKGROUND

Traditional evaluation systems often rely on static, predefined feedback mechanisms. While these systems can provide simple feedback, they lack the adaptability required to meet diverse user needs and can be ineffective for deeper learning or training applications. Static feedback mechanisms often result in limited user engagement, as they do not adjust based on user interactions or performance, potentially leading to a less effective learning experience.

With the recent rise of artificial intelligence (AI)-based solutions, adaptive systems that personalize feedback are becoming more common. AI-driven solutions aim to create a tailored experience by analyzing user input and adjusting responses accordingly. However, these systems come with significant drawbacks. AI systems typically require substantial computational resources to operate, often necessitating high-performance processors, extensive memory, and access to large datasets. Further, AI systems can have a large lag in response generation, making such systems feel sluggish.

Thus, there is a need for an adaptive, interactive evaluation process without imposing the high computational demands associated with traditional AI-based systems.

### BRIEF DESCRIPTION OF THE DRAWINGS

Embodiments are described in detail below, with reference to the following drawings:

FIG. 1 is a block diagram of an operating environment an evaluation system;

FIG. 2 is a block diagram showing an example arrangement of memory;

FIG. 3 is a block diagram of an example computing device in accordance with example embodiments;

FIG. 4 is an example arrangement of memory in accordance with example embodiments;

FIG. 5 is a flowchart of an example method of providing multimedia feedback in accordance with example embodiments;

FIG. 6 is a flowchart of a further example method of providing multimedia feedback in accordance with example embodiments;

FIG. 7 is a flowchart of a further example method of providing multimedia feedback in accordance with example embodiments;

FIG. 8 is an example display of an evaluation component in accordance with example embodiments;

FIG. 9 is an example output of a media payload in accordance with example embodiments; and

FIG. 10 is an example indicator in accordance with example embodiments.

Like reference numerals are used in the drawings to denote like elements and features.

### DETAILED DESCRIPTION OF VARIOUS EMBODIMENTS

In accordance with one aspect of the present disclosure, there is provided a computer-implemented method. The method may include: persisting, within a non-volatile data repository, an evaluation component that includes a query module and at least three response instances associated with the query module, where one response instance is designated as a validation-positive response instance and the other of the response instances are designated as validation-negative response instances; for each validation-negative response instance, storing a distinct media payload and establishing a mapping schema that associates each distinct media payload exclusively with its respective validation-negative response instance; transmitting the evaluation component from a source processing node to a target processing node over a communication network; receiving, over the communication network and at the source processing node, a response selection identifier from the target processing node that specifies one or more selected response instances; in response to receiving the response selection identifier, querying the non-volatile data repository to retrieve the media payload bound to one or more of the selected response instances and delivering the retrieved media payload to the target processing node to initiate an output event of the retrieved media payload at the target processing node; and initiating a monitoring sequence to detect a pre-configured activation condition in relation to the output event of the retrieved media payload on the target processing node, and, upon satisfaction of this activation condition, outputting an indicator on the target processing node indicating the validation-positive response instance.

In some implementations, the method may further include, for the response instance representing a validation-positive response instance, storing an additional media payload. The mapping schema may associate the additional media payload with the validation-positive response instance.

In some implementations, the mapping schema associates one of the response instances with a plurality of distinct media payloads. Retrieving the media payload associated with the selected response instance may include selecting one of the plurality of distinct media payloads mapped to the selected response instance based on a further parameter.

In some implementations, the further parameter may be a result indicator for one or more prior evaluation components.

In some implementations, the further parameter may be a score value indicating whether one or more response instances representing one or more validation-positive response instances were selected for the one or more prior evaluation components.

In at least some implementations, each of the plurality of distinct media payloads mapped to the selected response instance may indicate a basis for determining that the selected response instance does not correspond to the validation-positive response instance. One of the plurality of distinct media payloads mapped to the selected response instance may contain a basis having a larger duration than another of the plurality of distinct media payloads mapped to the selected response instance.

In at least some implementations, the method may further include modifying the score value based on whether the selected response instance corresponds to the validation-positive response instance.

In at least some implementations, the method may further include, in response to completion of a set of evaluation components, outputting the score value on the target processing node.

In at least some implementations, the media payload may be provided immediately to the target processing node for instantaneous rendering following receipt of input to provide real-time output of the media payload on the target processing node in response to the input.

In at least some implementations, the media payload may be an audio or video asset.

In at least some implementations, the mapping schema associates a particular set of the response instances with a distinct media payload. The query module may allow for selection of multiple response instances. Retrieving the media payload associated with the selected response instance may include retrieving the media payload associated with the set of response instance indicated by the selected response instances.

In at least some implementations, the mapping schema may associate a first one of the response instances with a plurality of media payloads. The query module may allow for selection of multiple response instances. Retrieving the media payload associated with the selected response instances may include, when the first one of the response instances is selected, retrieving a first one of the plurality of media payloads associated with the first one of the response instances when a second one of the response instances is also selected and retrieving a second one of the plurality of media payloads associated with the first one of the response instances when a third one of the response instances is also selected.

In an aspect, a source processing node is described. The source processing node may include a processor. The source processing node may include a communications module coupled to the processor. The source processing node may include a memory coupled to the processor. The memory may store instructions that, when executed, configure the processor to perform a method described herein. For example, the instructions may, when executed, configure the processor to: persist, within a non-volatile data repository, an evaluation component that includes a query module and at least three response instances associated with the query module, where one response instance is designated as a validation-positive response instance and the other of the response instances are designated as validation-negative response instances; for each validation-negative response instance, store a distinct media payload and establishing a mapping schema that associates each distinct media payload exclusively with its respective validation-negative response instance; transmit the evaluation component from the source processing node to a target processing node over a communication network; receive, over the communication network and at the source processing node, a response selection identifier from the target processing node that specifies a selected response instance; in response to receiving the response selection identifier, query the non-volatile data repository to retrieve the media payload bound to the selected response instance and deliver the retrieved media payload to the target processing node to initiate an output event of the retrieved media payload at the target processing node; and initiate a monitoring sequence to detect a pre-configured activation condition in relation to the output event of the retrieved media payload on the target processing node, and, upon satisfaction of this activation condition, output an indicator on the target processing node indicating the validation-positive response instance.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

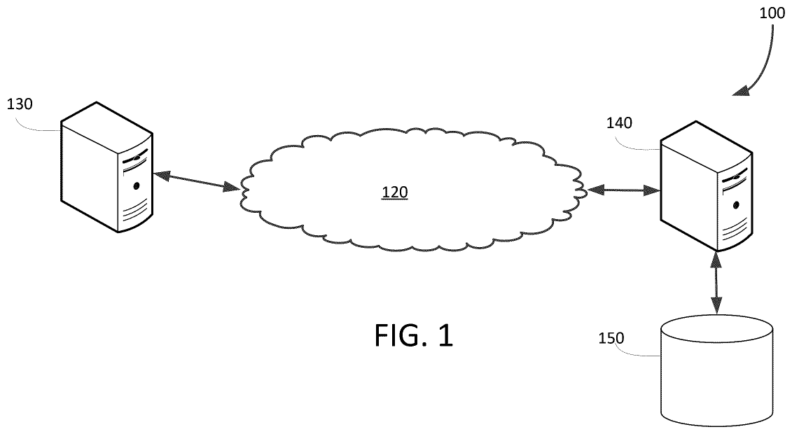

FIG. 1 illustrates an example computing environment 100 consistent with certain disclosed embodiments. As shown in FIG. 1, the computing environment 100 may include a source processing node 140, a target processing node 130, and a communication network 120 connecting one or more of the components of computing environment 100. The communication network 120 may include one or more wired or wireless networks, including the Internet.

In the computing environment 100, the source processing node 140 may serve as the starting point for data processing. This node may be responsible for receiving, processing, and, in at least some implementations, generating data before it is passed along to other components in the system, such as the target processing node 130. The source processing node 140 is equipped with computational resources, including processors, memory, and storage, that allow it to perform various operations. Such operations may range from data collection, distribution and transformation to more complex analysis or encoding. As will be explained in greater detail below, the source processing node 140 may be or may include one or more specialized servers, such as a media server and a web server, to handle specific types of data or communication tasks.

The source processing node 140 may include or be connected to a data repository 150. The data repository 150 may be a storage solution where data is kept before, during, or after processing. The data repository may be a non-volatile data repository. For example, the data stored in the data repository may be persistent even after the power is turned off. Non-volatile memory technologies, such as solid-state drives (SSDs), hard disk drives (HDDs), or even distributed storage systems like those used in cloud computing, may be employed in the data repository 150. In at least some implementations, the data repository 150 may include advanced features such as data indexing, query optimization, and caching to enhance the speed and efficiency of data retrieval.

The data repository 150 may, in various implementations, be referred to as one or more of the following: a data store, a database or a memory. The data repository 150 may be provided internally within the source processing node 140 or it may be separate. In some cases, the data repository 150 may be or include a data center.

The data repository 150 may reside internally within the source processing node 140 or externally in a distributed storage system, which may be part of a larger data center infrastructure. The data center may utilize advanced configurations such as redundant power supplies, failover systems, and backup generators to ensure continuous operation, even during power outages or hardware failures. In at least some implementations, the data repository 150 may be provided by or on a cloud-based data center.

The source processing node 140 may be a computing resource or a collection of computing resources. For example, the source processing node 140 may include one or more servers. The source processing node 140 may, for example, be or include a media server and/or a web server.

A media server integrated within or associated with the source processing node 140 may be specifically designed to handle multimedia data, such as audio and/or video. This type of server may be responsible for receiving, storing, processing, and distributing media content to clients or other systems within the environment. The media server may handle tasks such as transcoding media files (converting media from one format to another), streaming recorded content, or managing large libraries of multimedia data. The media server may be optimized for high-performance tasks, such as encoding and decoding video or audio in real time. The media server may ensure that content is properly formatted and optimized for distribution to end users or devices, such as the target processing node 130.

Alongside or in addition to a media server, the source processing node 140 may also include a web server, which handles the delivery of web-based content and services. A web server may be responsible for responding to Hypertext Transfer Protocol (HTTP) requests from clients, which could include browsers, mobile devices, or other networked systems including, for example, the target processing node 130. When a user or another system requests access to a particular resource, the web server processes the request, retrieves the necessary data from the source processing node or associated data repositories, and sends the response back to the requesting client. In some cases, the web server may interact with databases or other backend services to dynamically generate content, such as web pages, APIs, or interactive applications. The web server may handle other functions such as handling user authentication, managing session data, and supporting the integration of web-based applications or services with other parts of the computing environment. The integration of a web server within the source processing node 140 allows it to act as a point of entry for web clients or devices, enabling real-time access to data or services over the Internet.

Together, the media server and the web server may form part of a broader infrastructure that enhances the capabilities of the source processing node 140. The media server's role is particularly focused on the management and distribution of multimedia content, while the web server ensures that web-based communication and service delivery are handled efficiently. The source processing node 140 may not be a simple computational resource; it may be a versatile system capable of managing multiple types of data processing tasks, including multimedia management and web service handling.

The source and target processing nodes are connected via the communication network 120, which is responsible for transmitting data between them. This communication network 120 maintains data flow and connectivity between different components of the environment. The communication network 120 can be a combination of wired and wireless technologies, depending on the system's design and the geographical distribution of the nodes. The communication network 120 may also facilitates the integration of cloud-based services or remote data centers. In some implementations, the source processing node 140 may access the data repository 150 via the communication network 120.

Once data is processed or transformed within the source processing node 140, it may be sent over the communication network 120 to the target processing node 130. This node, like the source node, may be equipped with its own computing resources, including processors, memory, and storage, allowing it to handle further computations or analyses. In at least some implementations, the target processing node 130 is associated with one or more output device, such as a display and/or speaker. The output device may allow the target processing node 130 to output data received from the source processing node 140. Such data may include, for example, one or more of: an evaluation component, a query module, a response instance and/or a media payload.

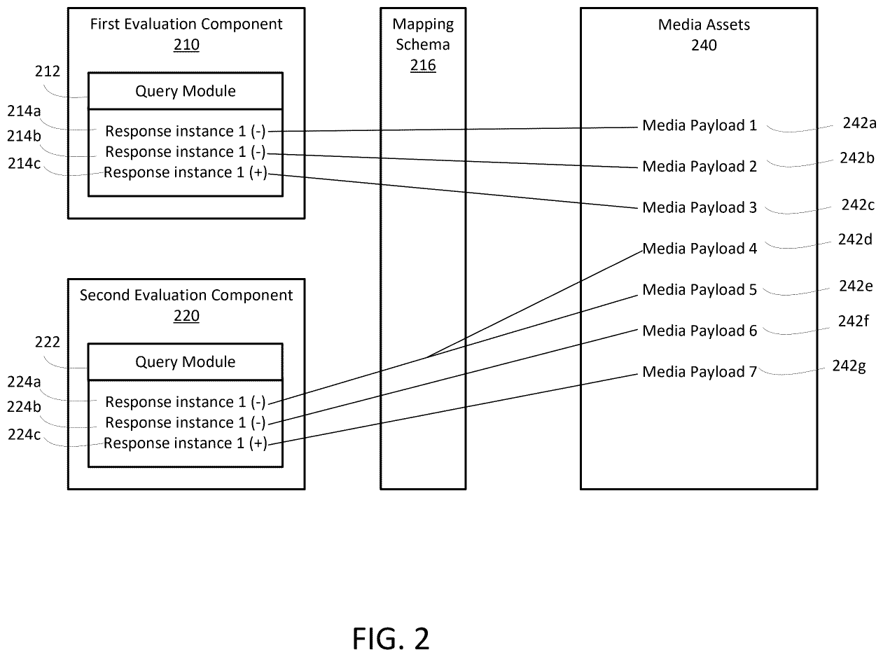

Reference will now be made to FIG. 2, which illustrates an example organization of data. The data may include one or more evaluation components. The evaluation components may include, for example, a first evaluation component 210 and a second evaluation component 220. An evaluation component may be a structured data processing algorithm in some implementations. The evaluation component may evaluate participant input through a discrete input-output function. The input may correspond to the user-provided response and the output may represent the system's evaluation of correctness based on a predefined reference dataset or decision matrix.

In at least some implementations, each evaluation component may include a query module and a plurality of response instances associated with the query module. A query module may be a prompt, such as a question. In at least some implementations, a query module may be associated with a set of non-binary response instances. That is, the evaluation component may include at least three response instances that are associated with the query module. For example, the first evaluation component 210 includes a query module 212 and three response instances 214a, 214b, 214c. In the example, a first and second ones of the response instances 214a, 214b represent validation-negative response instances and a third one of the response instances 214c represent a validation-positive response instance. In the illustrated example, a second evaluation component 220 includes a query module 222 and three response instances 224a, 224b, 224c. In the example, a first and second ones of the response instances 214a, 214b represent validation-negative response instances and a third one of the response instances 214c represent a validation-positive response instance for its associated query module. The validation-negative response instances may be considered an incorrect or erroneous input while the validation-positive response instances may be considered a proper, correct or approved response instance for its associated query module.

A query module may be or represent a prompt for input. The prompt may solicit input of the validation-positive response instance. The query module may solicit input that is related to content recently output on a target processing node 130, for example. That is, query module may prompt for input of a validation-positive response instance that should be derivable or determinable from content recently output on the target processing node 130.

A query module may be an input function within a decision-making algorithm, designed to process user selections from a predefined set of options. These options include the response instances. The user may be, via the query module, prompted to choose a response instances from a finite set of possible choices, and this selection is processed through a comparison operation where the input may be matched against a reference value which may be stored in a data structure, such as an array, dictionary, or hash table.

The comparison mechanism may employ an exact match algorithm, where the selected value is compared against the correct value stored in the reference set. If the user's input corresponds exactly to the correct option, the system determines that a validation-positive response instance has been input.

In some cases, the input may undergo preprocessing steps, such as input sanitization or type conversion, to ensure conformity to the expected format before the comparison is performed. Once the selection is evaluated, the result may be recorded in a state variable or data structure, which can be used to track progress, update scores, or trigger subsequent actions in the system.

The query module may operate as a discrete component of a larger evaluation engine, where the user's selection is mapped to a value in the reference set and assessed to determine correctness. This process may allow for efficient evaluation, enabling the system to provide immediate feedback and maintain an ongoing state of assessment across a sequence of interactions.

The data illustrated in FIG. 2 also include media assets 240. These may include one or more media payloads 242a-242g. For each validation-negative instance, a distinct media payload 242a-242g may be stored. A distinct media payload 242a-242g may also be stored for one or more of the validation-positive instances. In this way, each validation-negative instance and, in at least some implementations, each validation-positive instance may be associated with a separate media payload.

Each media payload may be an audio or video asset. A video asset may be a digital medium that represents a sequence of visual images and audio signals encoded into a specific format, often comprising frames displayed at a fixed rate (e.g., 30 frames per second). These frames are typically compressed using video codecs (such as H.264 or HEVC) to reduce data size while maintaining visual and auditory fidelity. The video signal is typically synchronized with an audio track, which is encoded using audio compression algorithms (e.g., AAC or MP3). Playback is achieved through decoding processes that reconstruct the visual frames and audio stream for display and sound output on a compatible device, such as the target processing node 130.

An audio asset is a digital representation of sound waves, typically encoded as a sequence of samples representing amplitude values over time. These samples are often compressed using audio codecs (such as MP3 or AAC) to reduce file size while preserving sound quality. The audio data may be decoded at a target processing node 130 and converted into an analog signal by a digital-to-analog converter (DAC) for playback through speakers or headphones.

The data illustrated in FIG. 2 may also include a mapping schema 216. The mapping schema 216 may associate media payloads with respective response instances. For example, the mapping schema 216 may associate a distinct media payload with its respective validation-negative or validation positive response instance. The association may be an exclusive one. That is, each media payload may be associated with one and only one response instance.

In some instances, more than one media payload may be associated with a particular response instance. For example, FIG. 2 shows two media payloads 242d, 242e associated with a particular response instance 224a. In this case, the two media payloads 242d, 242e are associated with a negative particular response instance 224a. In at least some such cases, selection definition data may be stored. Such selection definition data may indicate a basis for selecting which of the media payloads are to be used in response to selection of the particular response instance 224a. For example, the selection definition data may indicate whether a first media payload 242d or a second media payload 242e is to be selected and used for output at the target processing node 130 in response to a selection of the particular response instance 224a. This selection definition data may specify criteria that is to be used in association with a parameter. The parameter may be, for example, a score value. The score value may indicate a success metric for past evaluation components. If the score value indicates a sufficiently high past performance, then the first media payload 242d may be selected and, if not, then the second media payload 242e may be selected. Sufficiently high may be evaluated relative to a threshold.

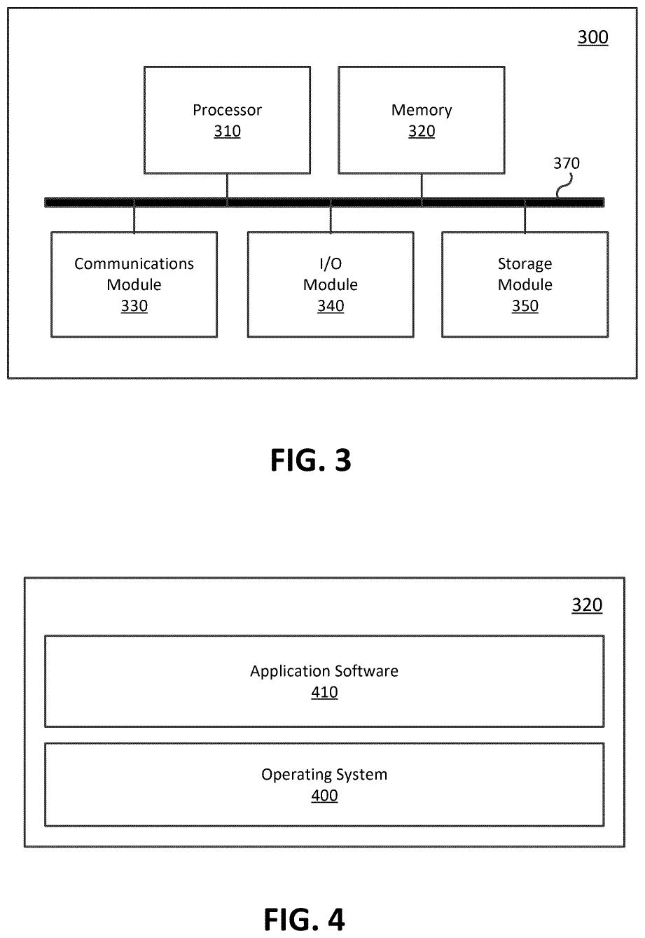

Reference will now be made to FIG. 3. FIG. 3 is a simplified schematic diagram showing components of an exemplary computing device 300.

The target processing node 130 and/or source processing node 140 may be of the same type as the computing device 300.

The computing device 300 includes a variety of modules. For example, as illustrated, the example computing device 300 may include a processor 310, a memory 320, a communications module 330, an Input/Output (I/O) module 340, and/or a storage module 350. As illustrated, the foregoing example modules of the example computing device 300 are in communication over a bus 370. As such, the bus 370 may be considered to couple the various modules of the computing device 300 to each other, including, for example, to the processor 310.

The processor 310 is a hardware processor. The processor 310 may, for example, be one or more ARM, Intel x86, PowerPC processors or the like.

The memory 320 allows data to be stored and retrieved. The memory 320 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the computing device 300.

The communications module 330 allows the computing device 300 to communicate with various communications networks and/or other computing devices. For example, the communications module 330 may allow the computing device 300 to send or receive communications signals. Communications signals may be sent or received according to one or more protocols or according to one or more standards. The communications module 330 may allow the computing device 300 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE), 5G or the like. Additionally or alternatively, the communications module 330 may allow the computing device 300 to communicate using near-field communication (NFC), via Wi-Fi™, using Bluetooth™ or via some combination of one or more networks or protocols. In some embodiments, all or a portion of the communications module 330 may be integrated into a component of the computing device 300. For example, the communications module 330 may be integrated into communications circuitry, such as a communications chipset. The communications module 330 may be referred to as one or more of the following in various implementations: communication hardware, a communication device, a communication chipset and/or a communication subsystem.

The I/O module 340 is an input/output module. The I/O module 340 allows the computing device 300 to receive input from and/or to provide input to components of the computing device 300 such as, for example, various input modules and output modules. For example, the I/O module 340 may allow the computing device 300 to receive input from and/or provide output to a display (not shown).

The storage module 350 allows data to be stored and retrieved. In some embodiments, the storage module 350 may be formed as a part of the memory 320 and/or may be used to access all or a portion of the memory 320. Additionally or alternatively, the storage module 350 may be used to store and retrieve data from persisted storage other than the persisted storage (if any) accessible via the memory 320. In some embodiments, the storage module 350 may be used to store and retrieve data in/from a database. A database may be stored in persisted storage. Additionally or alternatively, the storage module 350 may access data stored remotely such as, for example, as may be accessed using a local area network (LAN), wide area network (WAN), personal area network (PAN), and/or a storage area network (SAN). In some embodiments, the storage module 350 may access data stored remotely using the communications module 330. In some embodiments, the storage module 350 may be omitted and its function may be performed by the memory 320 and/or by the processor 310 in concert with the communications module 330 such as, for example, if data is stored remotely.

Software comprising instructions is executed by the processor 310 from a computer-readable medium. For example, software may be loaded into random-access memory from persistent storage of the memory 320. Additionally or alternatively, instructions may be executed by the processor 310 directly from read-only memory of the memory 320.

FIG. 4 depicts a simplified organization of software components stored in the memory 320 of the computing device 300. As illustrated, these software components include an operating system 400 and an application software 410.

The operating system 400 is software. The operating system 400 allows the application software 410 to access the processor 310 (FIG. 3), the memory 320, the communications module 330, the I/O module 340, and the storage module 350 of the computing device 300. The operating system 400 may be, for example, Google™ Android™, Apple™ iOS™, UNIX™, Linux™, Microsoft™ Windows™, Apple OSX™ or the like.

The application software 410 adapts the computing device 300, in combination with the operating system 400, to operate as one ore more of the target processing node 130 and/or source processing node 140.

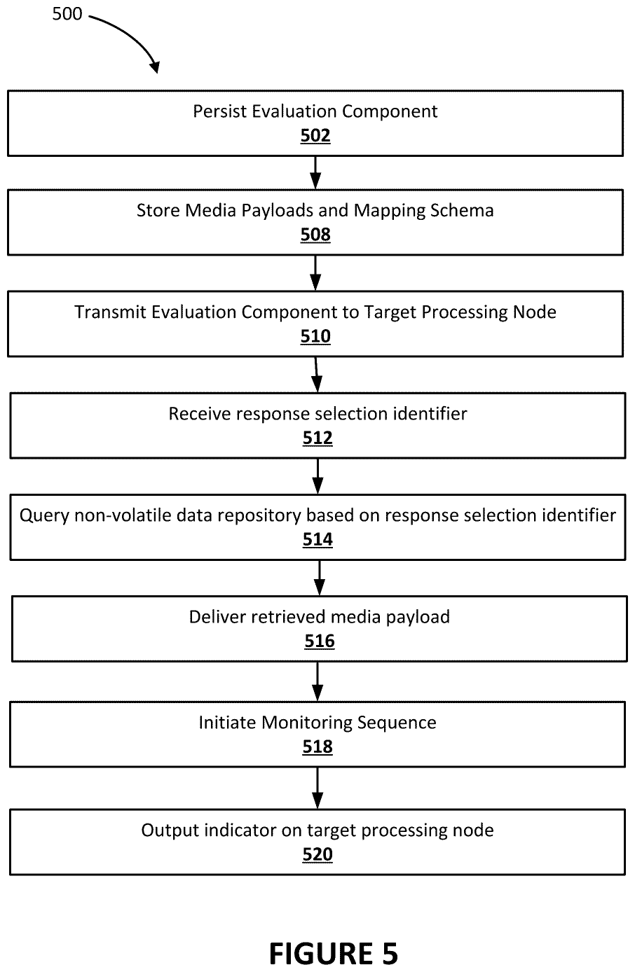

Reference is now made to FIG. 5, which shows, in flowchart form, an example method 500 of providing a media payload from a source processing node 140 to a target processing node 130. The method 500 may be implemented by a computing system, such as the source processing node 140 (FIGS. 1 and 2). For example, a software module may be configured to cause the source processing node 140 of FIG. 1 to implement the method 500. The method 500 may be performed, for example, by the processor 310 (FIG. 3) of a computer device 300 executing software comprising instructions such as may be stored in the memory 320 of the computer device 300. More particularly, processor-executable instructions may, when executed, configure a processor 310 of a computing system such as the source processing node 140 to perform all or parts of the method 500 or a portion thereof.

In performing the method 500, the source processing node 140 may cooperate with other systems and devices such as, for example, the target processing node 130 and/or the data repository 150. Each of these devices may be configured with processor-executable instructions which cause such devices to perform methods which cooperate with the method 500.

Further, at least some operations described as being performed by one system may be performed by a different system.

Prior to performing the method 500, the source processing node 140 may initiate a session with the target processing node 130. During this session, and prior to the method 500, the source processing node 140 may perform various operations, such as authenticating the target processing node 130 as being associated with a particular account and/or execute a training module. The training module may provide content associated with a particular topic to the target processing node 130. The content may include multimedia content, such as video-based content. In at least some implementations, the content defines a syntax that may be used in a particular operating environment. By way of example, the syntax may relate to computer coding syntax and/or grammatical or speech rules.

At an operation 502, the method 500 may include persisting, within a non-volatile data repository, an evaluation component. The evaluation component may be of a type described above; for example, with reference to FIG. 2. For example, the evaluation component may include a query module. The evaluation component may include at least three response instances. Each of the response instances are associated with the query module. One of the response instances may be designated, in the data repository, as a validation-positive response instance. The other of the response instances may be designated as validation-negative response instances.

At an operation 508, the method 500 may include, for each validation-negative response instance, storing a distinct media payload. Put differently, each validation-negative response instance for a given query module may be associated with a different media payload. Each media payload may be an audio or video asset, for example.

The method 500 may also include, for the validation-positive response instance, storing a distinct media payload. This media payload may be referred to as an additional media payload. The media payload stored for the validation-positive response instance may be different than the media payload for any of the validation-negative response instances. The mapping schema may associate the additional media payload with the validation-positive instance.

At the operation 508, the method 500 may also include establishing a mapping schema that associates each distinct media payload exclusively with a respective response instance. The mapping schema may be defined and stored during operation 508 along with the media payload or the defining and storing of the mapping schema may be separated into a different operation.

The mapping schema may be as described above with respect to FIG. 2. The media payloads may be of the type described above with reference to FIG. 2.

At an operation 510, the method may include transmitting the evaluation component from a source processing node to a target processing node over a communication network. The transmitting may be performed in response to a triggering condition being satisfied. For example, the operation 510 may be performed in response to completion of delivery of particular content. The particular content may represent a final item of content in a content set. The content set may be associated with one or more of a pedagogical block, learning algorithm, educational subsystem, cognitive segment, knowledge delivery unit, instructional component, learning pathway, content unit, academic submodule, learning schema, didactic matrix or curriculum node. The evaluation component may be stored in association with the particular content such that, when delivery of the particular content completes, the system may then automatically deliver the evaluation component stored in association with that content.

Once the evaluation component is transmitted to the target processing node, it may be output on an output interface associated with the target processing node. For example, the evaluation component may be output on a display associated with the target processing node.

Interface elements may be associated with each of the response instances that are displayed at the target processing node. Put differently, the response instances may be selectable.

At an operation 512, the source processing node may receive, over the communication network, a response selection identifier. The response selection identifier may be received from the target processing node. The response selection identifier may specify a selected response instance. That is, the response selection identifier may specify which of the response instances were selected.

At an operation 514, the source processing node may, in response to receiving the response selection identifier, query the non-volatile data repository to retrieve the media payload bound to the selected response instance. This operation may be performed using the mapping schema. That is, the mapping schema may be used to identify the media payload that is associated with the selected response instance.

At an operation 516, the source processing node may deliver the retrieved media payload to the target processing node to initiate an output event of the retrieved media payload at the target processing node. For example, the retrieved media payload may be output on a display associated with the target processing node.

In at least some implementations, the media payload may be provided immediately to the target processing node for instantaneous rendering following the receipt of input at the operation 512. In this way, the system may provide real-time output of the media payload on the target processing node in response to the input.

At an operation 518, the source processing node may initiate a monitoring sequence after the operation 516. The source processing node may initiate the monitoring sequence to detect a pre-configured activation condition in relation to the output event of the retrieved media payload on the target processing node. The monitoring sequence may, for example, detect completion of playback of the media payload on the target processing node.

Upon satisfaction of this activation condition (which may be detected at the operation 518), the source processing node may, at an operation 520, output an indicator on the target processing node indicating the validation-positive instance. In at least some implementations, the operation 520 may only be performed if a validation-negative response instance was selected. That is, it may not be performed if a validation-positive response instance was performed. The indicator may indicate which of the response instances is the validation-positive response instance.

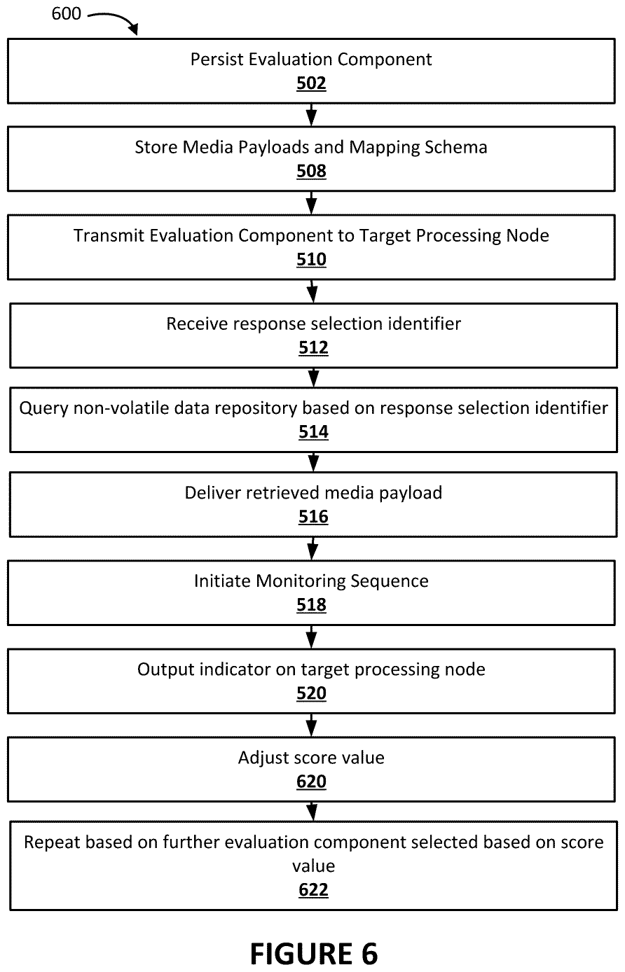

The method 500 may be modified. For example, some example modifications will now be described with reference to FIG. 6. FIG. 6 shows, in flowchart form, an example method 600 of providing a media payload from a source processing node 140 to a target processing node 130. The method 600 may be implemented by a computing system, such as the source processing node 140 (FIGS. 1 and 2). For example, a software module may be configured to cause the source processing node 140 of FIG. 1 to implement the method 600. The method 600 may be performed, for example, by the processor 310 (FIG. 3) of a computer device 300 executing software comprising instructions such as may be stored in the memory 320 of the computer device 300. More particularly, processor-executable instructions may, when executed, configure a processor 310 of a computing system such as the source processing node 140 to perform all or parts of the method 600 or a portion thereof.

In performing the method 600, the source processing node 140 may cooperate with other systems and devices such as, for example, the target processing node 130 and/or the data repository 150. Each of these devices may be configured with processor-executable instructions which cause such devices to perform methods which cooperate with the method 600.

Further, at least some operations described as being performed by one system may be performed by a different system.

Prior to performing the method 600, the source processing node 140 may initiate a session with the target processing node 130.

The method 600 may include operations in common with the method 500 of FIG. 5. Such operations are indicated by common reference number and the description of such operations will not be repeated.

As described above, at an operation 502, the method 600 may include persisting an evaluation component and, at an operation 508, storing media payloads and a mapping schema. In this example, however, the mapping schema associates one of the response instances with a plurality of distinct media payloads. That is, at least one of the response instances may be mapped to two or more different media payloads.

The operations 510 to 512 may be performed as described above with reference to FIG. 5.

At the operation 514, which may also be performed as described above with reference to FIG. 5, retrieving the media payload associated with the selected response instance may include selecting one of the plurality of distinct media payloads mapped to the selected response instance based on a further parameter. That is, the media payload may be selected based on both the selected response instance and the further parameter.

The further parameter that is used at the operation 514 may be a result indicator for one or more prior evaluation components. For example, the further parameter may be a score value indicating whether one or more of the response instances representing one or more validation-positive response instances were selected for the one or more prior evaluation components. That is, the further parameter may be a measure of success on prior evaluation components.

Where a particular negative response instance is mapped to more than one media payload, the media payloads may each indicate a basis for determining that the selected response instance does not correspond to the validation-positive response instance. The basis may be an explanation or elucidation. One of the plurality of distinct media payloads that is mapped to a response instance that is mapped to multiple media payloads may contain a basis having a larger duration than another of the plurality of distinct media payloads mapped to the selected response instance. For example, an explanation as to why the selected response instance was not the validation-positive response instance may be more detailed and/or longer in one of the media payloads than in another of the media payloads.

The method 600 may include the operations 516-520 during which the media payload is delivered (operation 516), a monitoring sequence is initiated (operation 518) and an indicator is output on the target processing node (operation 520).

The method 600 may also include an operation 620 in which a parameter is defined or adjusted. For example, a score may be adjusted at the operation 620. The score may be adjusted based on whether or not the validation-positive response instance was selected. That is, a score value may be modified based on whether the selected response instance corresponds to the validation-positive response instance. If the validation-positive response instance was selected, the score value may be improved. If the validation-positive response instance was not selected, the score value may be made relatively worse.

The score value may be output at the target processing node in response to completion of a set of evaluation components. The set of evaluation components may be a set associated with a particular pedagogical block, learning algorithm, educational subsystem, cognitive segment, knowledge delivery unit, instructional component, learning pathway, content unit, academic submodule, learning schema, didactic matrix or curriculum node.

The score value may also be used in a subsequent iteration of the method 600. For example, it may be used at the operation 514 in a further iteration of the method 600.

In some implementations, at least some of the operations of the method 600 may be repeated. This is indicated at an operation 622. For example, the operations, 510-620 may be repeated based on a further evaluation component. In at least some implementations, the further evaluation component may be selected based on a score value. For example, a threshold may be used in the selection. In an example, if the score value is less than a threshold, one evaluation component may be used and if the score value is above the threshold, another evaluation component may be used.

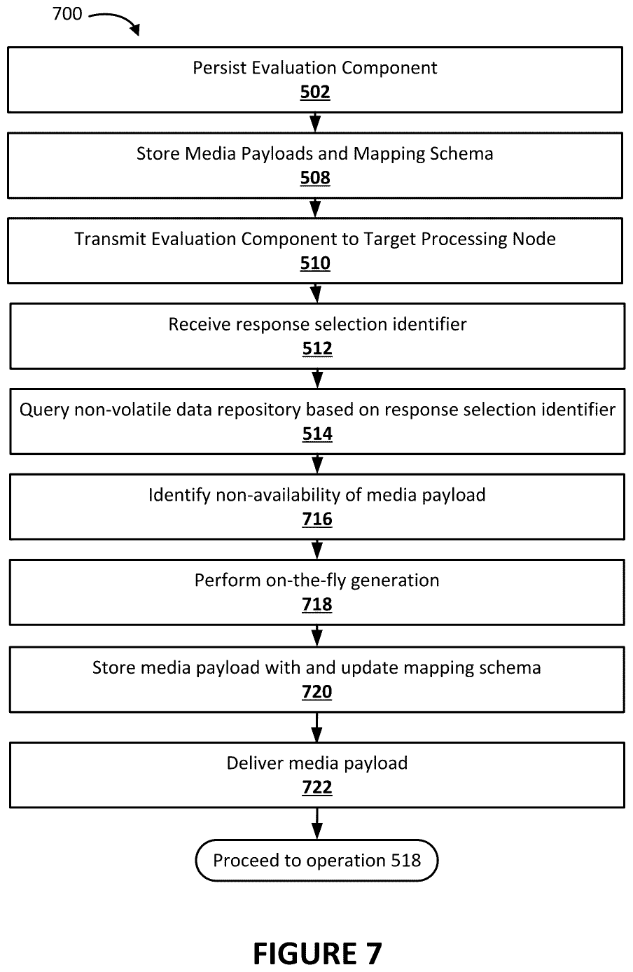

A further example modification will now be described with reference to FIG. 7. FIG. 7 shows, in flowchart form, an example method 700 of providing a media payload from a source processing node 140 to a target processing node 130. The method 700 may be implemented by a computing system, such as the source processing node 140 (FIGS. 1 and 2). For example, a software module may be configured to cause the source processing node 140 of FIG. 1 to implement the method 700. The method 700 may be performed, for example, by the processor 310 (FIG. 3) of a computer device 300 executing software comprising instructions such as may be stored in the memory 320 of the computer device 300. More particularly, processor-executable instructions may, when executed, configure a processor 310 of a computing system such as the source processing node 140 to perform all or parts of the method 700 or a portion thereof.

In performing the method 700, the source processing node 140 may cooperate with other systems and devices such as, for example, the target processing node 130 and/or the data repository 150. Each of these devices may be configured with processor-executable instructions which cause such devices to perform methods which cooperate with the method 700.

Further, at least some operations described as being performed by one system may be performed by a different system.

Prior to performing the method 700, the source processing node 140 may initiate a session with the target processing node 130.

The method 700 may include operations in common with the methods 500 of FIGS. 5 and 600 of FIG. 6. Such operations are indicated by common reference number and the description of such operations will not be repeated.

As described above, at an operation 502, the method may include persisting an evaluation component and, at an operation 508, storing media payloads and a mapping schema. In this example, however, the mapping schema associates one of the response instances with a plurality of distinct media payloads. That is, at least one of the response instances may be mapped to two or more different media payloads.

The operations 510 to 514 may be performed as described above with reference to FIGS. 5 and/or 6.

In some instances, at the operation 514, the source processing node may identify, at an operation 716, that a media payload is not available. For example, a particular response instance may not have a media payload mapped to it or it may not have a media payload mapped to it that would be usable in view of the further parameter. In such instances, the source operating node identifies, at the operation 716, that a media payload is not available.

In response to identifying non-availability of the media payload, the source processing node may perform on-the-fly generation at an operation 718. During this operation, the source processing node may generate a suitable media payload. This generating may, in at least some implementations, be performed using a large language model (LLM). The LLM may be generativeAI (genAI). For example, the LLM may be a generativeAI capable of generating media based on a prompt.

At the operation 718, the source processing node may provide the evaluation component or a portion thereof to the LLM. For example, the source processing node may provide the query module, the selected response instance and the positive response instance to the LLM. The source processing node may provide the evaluation component or portion thereof to the LLM together with a prompt. The prompt may be a computer instruction to cause the LLM to generate a media payload that explains why the selected response instance is a validation-negative response instance and not a validation-positive response instance.

In this way, if there is not yet a media payload that has been generated and stored, it may be generated on-the-fly using an LLM.

After on-the-fly generation has been performed, the generated media payload may be stored at an operation 720 and the mapping schema may be updated to associate the selected response instance that generated and stored media payload. In some instances, the mapping schema pay also map the stored media payload particular parameter criteria. The mapping schema may be used by multi users. For example, the mapping schema may be used across an entire user base or at least across a set of users satisfying particular criteria (e.g., who are all associated with a common language). In this way, the generated media payload may be used in subsequent iterations of the method 700 for other users without having to regenerate that media payload. This may allow the set of media payloads to grow. For example, the initial set of media payloads may all be generated without AI or an LLM. The initial set of media payloads may all be recorded, for example. However, further sets of media payloads may be generated using AI/LLM on-the-fly to ensure that media payloads are available for even edge cases.

The media payload may also be delivered at an operation 722. The operation 722 may be performed similar to the operation 516 of the method 500 of FIG. 5.

The operations 518, 520 and, in some instances, 620 and 622 of the methods 500, 600 of FIGS. 5 and 6 may be performed after the operation 722.

The method 700 of FIG. 7 may also be modified to use an LLM to generate further evaluation components. That is, a set of evaluation components may be initially defined without the use of an LLM/AI but some users may not have a sufficiently high score based on a threshold after the available evaluation components have been completed. In at least some such scenarios, the system may generate further evaluation components on-the-fly. This may be performed during the operation 718 and/or using similar techniques to those described above with reference to operation 718. Thus the curated evaluation components may be supplemented with AI-generated evaluation components for users that have not achieved a sufficiently high score following the curated evaluation components. In this way, the system could provide essentially infinite learning capabilities in a manner that optimizes the use of available computing resources.

Any evaluation components that are generated using LLM/AI may be stored for future use by other users.

Further, the system may have the capability to cull one or more evaluation components and/or media payloads based on monitored performance following such evaluation components/media payloads. That is, the system may remove evaluation components and/or media payloads so that they are not used by other users in the future if the system determines that performance is not improved following delivery of those evaluation components and/or media payloads. For example, if most users do not improve in a particular way following delivery of a particular evaluation component and/or particular media payload, then that evaluation component/media payload may be removed. If, for example, trend data or other historical data indicates that a same mistake is being made in subsequent evaluation components, then the system may determine that a particular evaluation component and/or media payload was not helpful and it may generate a new one.

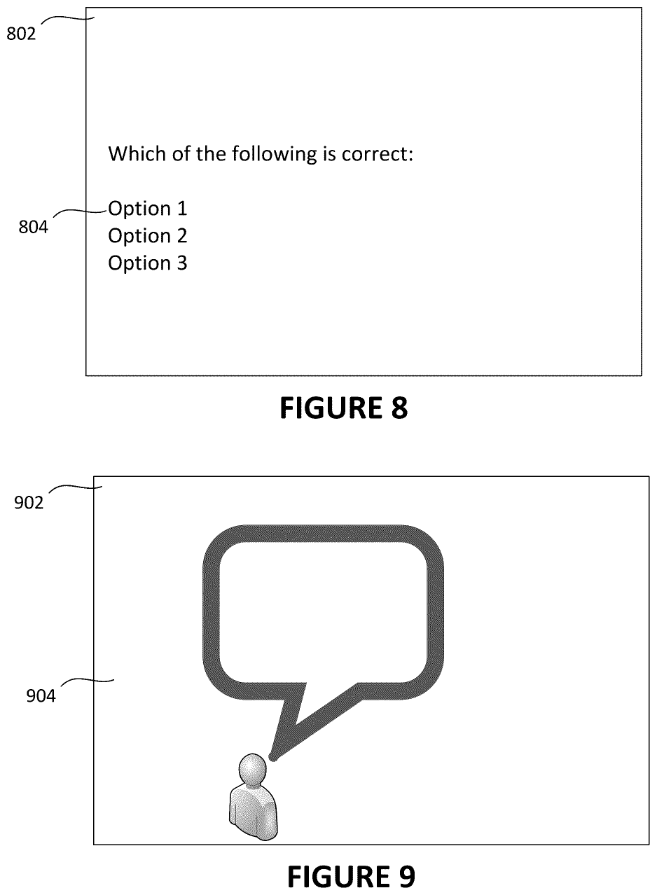

Reference will now be made to FIG. 8, which illustrates an example interface 802. The interface 802 may be displayed at a target processing node. The interface 802 includes an evaluation component 804. The interface 802 may be displayed, for example, immediately after the operation 510 of the methods 500, 600, 700.

Reference will now be made to FIG. 9, which illustrates a further example interface 902. The interface 902 may be displayed at a target processing node. The interface 902 includes a representation of a media payload 904. The interface 902 may be displayed immediately after or during the operation 516 of the methods 500, 600, 700.

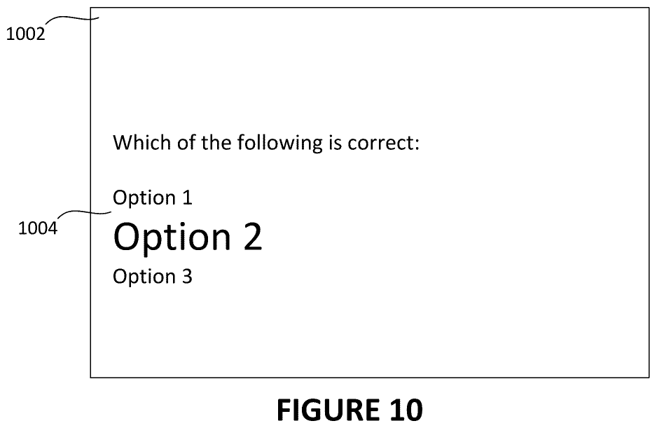

Reference will now be made to FIG. 10, which illustrates a further example interface 1002. The interface 1002 may be displayed at a target processing node. The interface 1002 includes an indicator 1004 indicating a validation-positive instance. The interface 1002 may be displayed immediately after or during the operation 516 of the methods 500, 600, 700.

The methods and systems described herein may be modified. For example, some query modules may allow for selection of multiple response instances. Some response instances may be associated with more than one media payload and the appropriate one of the media payloads may be selected based on a set of selected response instances. For example, if a first and third response instances are selected, the media payload may be different than if a first and second response instances are selected. This may allow for very targeted feedback in a manner that would appear to the user as though it is AI-generated on the fly.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

What is claimed is:

1. A computer-implemented method comprising:
persisting, within a non-volatile data repository, an evaluation component that includes a query module and at least three response instances associated with the query module, where at least one response instance is designated as a validation-positive response instance and the other of the response instances are designated as validation-negative response instances;
for each validation-negative response instance, storing a distinct media payload and establishing a mapping schema that associates each distinct media payload exclusively with its respective validation-negative response instance;
transmitting the evaluation component from a source processing node to a target processing node over a communication network;
receiving, over the communication network and at the source processing node, a response selection identifier from the target processing node that specifies one or more selected response instances;
in response to receiving the response selection identifier, querying the non-volatile data repository to retrieve the media payload bound to one or more of the selected response instances and delivering the retrieved media payload to the target processing node to initiate an output event of the retrieved media payload at the target processing node; and
initiating a monitoring sequence to detect a pre-configured activation condition in relation to the output event of the retrieved media payload on the target processing node, and, upon satisfaction of this activation condition, outputting an indicator on the target processing node indicating the validation-positive response instance.

2. The computer-implemented method of claim 1, further comprising, for the response instance representing a validation-positive response instance, storing an additional media payload and wherein the mapping schema associates the additional media payload with the validation-positive response instance.

3. The computer-implemented method of claim 1, wherein the mapping schema associates one of the response instances with a plurality of distinct media payloads, and wherein retrieving the media payload associated with the selected response instance includes selecting one of the plurality of distinct media payloads mapped to the selected response instance based on a further parameter.

4. The computer-implemented method of claim 3, wherein the further parameter is a result indicator for one or more prior evaluation components.

5. The computer-implemented method of claim 4, wherein the further parameter is a score value indicating whether one or more response instances representing one or more validation-positive response instances were selected for the one or more prior evaluation components.

6. The computer-implemented method of claim 5, wherein each of the plurality of distinct media payloads mapped to the selected response instance indicates a basis for determining that the selected response instance does not correspond to the validation-positive response instance, and wherein one of the plurality of distinct media payloads mapped to the selected response instance contains a basis having a larger duration than another of the plurality of distinct media payloads mapped to the selected response instance.

7. The computer-implemented method of claim 6, further comprising modifying the score value based on whether the selected response instance corresponds to the validation-positive response instance.

8. The computer-implemented method of claim 7, further comprising, in response to completion of a set of evaluation components, outputting the score value on the target processing node.

9. The computer-implemented method of claim 1, wherein the media payload is provided immediately to the target processing node for instantaneous rendering following receipt of input to provide real-time output of the media payload on the target processing node in response to the input.

10. The computer-implemented method of claim 1, wherein the media payload is an audio or video asset.

11. The computer-implemented method of claim 1, wherein the mapping schema associates a particular set of the response instances with a distinct media payload, and wherein the query module allows for selection of multiple response instances and wherein retrieving the media payload associated with the selected response instance includes retrieving the media payload associated with the set of response instance indicated by the selected response instances.

12. The computer-implemented method of claim 1, wherein the mapping schema associates a first one of the response instances with a plurality of media payloads and wherein the query module allows for selection of multiple response instances, and wherein retrieving the media payload associated with the selected response instances includes, when the first one of the response instances is selected, retrieving a first one of the plurality of media payloads associated with the first one of the response instances when a second one of the response instances is also selected and retrieving a second one of the plurality of media payloads associated with the first one of the response instances when a third one of the response instances is also selected.

13. A source processing node comprising:
a processor;
a communications module coupled to the processor; and
a memory coupled to the processor, the memory storing instructions that, when executed, configure the processor to:
persist, within a non-volatile data repository, an evaluation component that includes a query module and at least three response instances associated with the query module, where at least one response instance is designated as a validation-positive response instance and the other of the response instances are designated as validation-negative response instances;
for each validation-negative response instance, store a distinct media payload and establishing a mapping schema that associates each distinct media payload exclusively with its respective validation-negative response instance;
transmit the evaluation component from the source processing node to a target processing node over a communication network;
receive, over the communication network and at the source processing node, a response selection identifier from the target processing node that specifies one or more selected response instances;
in response to receiving the response selection identifier, query the non-volatile data repository to retrieve the media payload bound to one or more of the selected response instances and deliver the retrieved media payload to the target processing node to initiate an output event of the retrieved media payload at the target processing node; and
initiate a monitoring sequence to detect a pre-configured activation condition in relation to the output event of the retrieved media payload on the target processing node, and, upon satisfaction of this activation condition, output an indicator on the target processing node indicating the validation-positive response instance.

14. The source processing node of claim 13, wherein the instructions further configure the processor to: for the response instance representing a validation-positive response instance, store an additional media payload and wherein the mapping schema associates the additional media payload with the validation-positive response instance.

15. The source processing node of claim 14, wherein the mapping schema associates one of the response instances with a plurality of distinct media payloads, and wherein retrieving the media payload associated with the selected response instance includes selecting one of the plurality of distinct media payloads mapped to the selected response instance based on a further parameter.

16. The source processing node of claim 15, wherein the further parameter is a result indicator for one or more prior evaluation components.

17. The source processing node of claim 16, wherein the further parameter is a score value indicating whether one or more response instances representing one or more validation-positive response instances were selected for the one or more prior evaluation components.

18. The source processing node of claim 17, wherein each of the plurality of distinct media payloads mapped to the selected response instance indicates a basis for determining that the selected response instance does not correspond to the validation-positive response instance, and wherein one of the plurality of distinct media payloads mapped to the selected response instance contains a basis having a larger duration than another of the plurality of distinct media payloads mapped to the selected response instance.

19. The source processing node of claim 18, wherein the instructions further configure the processor to modify the score value based on whether the selected response instance corresponds to the validation-positive response instance.

20. The source processing node of claim 19, wherein the instructions further configure the processor to, in response to completion of a set of evaluation components, output the score value on the target processing node.
